(19) United States
(12) Patent Application Publication
(10) Pub. No.: US 2003/0106055 A1
(43) Pub. Date: Jun. 5, 2003

(54) On-line advertisement mechanism

(76) Inventor: Ilkka Kukkonen, Espoo (FI)

Correspondence Address: YOUNG & THOMPSON, 745 SOUTH 23RD STREET 2ND FLOOR, ARLINGTON, VA, 22202

(21) Appl. No.: 10/149,387

(22) PCT Filed: Dec. 15, 2000
(86) PCT No.: PCT/FI00/01104

(30) Foreign Application Priority Data
Dec. 16, 1999 (FI) 19992700

(51) Int. Cl. H04N 5/445

(52) U.S. Cl. 725/39

(57) ABSTRACT

A method for delivering advertising information (AD) from a service provider (SP) to a client (C). The method comprises the steps of: 1) maintaining an advertising data base (ADB) comprising selectable advertising records (SAR), each advertising record being directly or indirectly associated with an item (39a) and an item profile (IP1 - IP4); 2) determining at least one characteristic parameter, preferably a home address, (HA) of the client (C); 3) using the characteristic parameter (HA) to determine a typical consumer profile (TCP) which is typical of a predetermined number of people having substantially the same characteristic parameter (HA); 4) selecting, among the selectable advertising records (SAR), at least one advertising record (39) which is associated with an item profile (IP1) which matches the typical consumer profile (TCP), and 5) extracting at least one item (39a) for advertising to the client (C) from the selected advertising record/s (39).

### BACKGROUND OF THE INVENTION

The invention relates to methods and equipment for delivering customized advertisements to customers.

A general problem with advertising is that most of the time, customers are flooded with advertisements which are irrelevant to their current activities. In other words, most advertisements are related to products or services in which the viewer is not at all interested, or the viewer could be interested in the advertisement, but only at a more appropriate time.

Advertisers fiercely compete for a non-extendible resource, namely the perceptive ability of the potential customers. It has been estimated that one contemporary newspaper issue contains as much information as a typical 17th-century citizen received during his or her lifetime. As a result, the advertisers are in a zero-sum competition wherein the gain of one medium or advertiser is the loss of another.

Advertisers try to make educated guesses at the needs of their potential customers. For instance, when an Internet user views the web pages of an on-line vendor, the vendor may assume that the user in question has at least a mild interest in telecommunications, web browsing, etc., and consequently, the initial advertisements are typically selected from such items. An advertiser may employ a system which selects an advertisement from a database by using simple correlation between data entered by the user and the advertisement. For example, entering the word ‘trousers’ into a web search engine may result in an advertisement for a clothing company being displayed. When the user makes a purchase, his/her identity is stored and the next time s/he views the same vendor's web pages, s/he may be shown an advertisement based on previous purchase behaviour. However, a hit on a certain web page or an on-line purchase from the vendor gives little or no actual information on the user's future behaviour. For instance, a business may have been buying computers regularly, but in fact their last computer purchase was the last one needed in the foreseeable future, and no further computers will be needed. Thus prior art advertisement delivery mechanisms are based on predictions of user behaviour which are extrapolated from current or past behaviour. Such extrapolation may lead to false conclusions, which is why prior art advertisement delivery mechanisms provide irrelevant information and thus waste economical and technical resources.

A partial solution to this problem is provided by customer profiles by which a customer's interests and buying patterns are tracked and the information thus obtained is used for advertisement selection. However, such schemes are useless during a given customer's few initial contacts when information on this particular customer's buying patterns is not available. Also, many countries impose limitations on what kind of information can be collected for advertisement purposes.

### DISCLOSURE OF THE INVENTION

An object of the invention is to provide a mechanism for advertisement delivery which provides more relevant information than the prior art mechanisms do. This object is achieved with a method and equipment which are characterized by what is disclosed in the attached independent claims. Preferred embodiments of the invention are disclosed in the attached dependent claims.

The invention is based on the idea that the functions of advertisement selection and customer tracking (or profiling) are divided between two separate entities. The following terminology will be used for describing the invention. A ‘consumer’ is a person potentially interested in certain products, services or information, commonly referred to as items. The person actually receiving the advertisement (as a result of requesting a service or information) is called a ‘client’. (Logically, the advertisement is sent to the client, but technically, it is sent to the client's terminal equipment.) An ‘advertiser’ is one of the organizations whose advertisements will be shown to the client. A ‘profile provider’ is an organization that maintains typical consumer profiles. They are profiles which are typical for a number of customers sharing at least one common characteristic parameter, such as a home address. A ‘service provider’ is the organization that combines the service/information which the user actually wants with a selected advertisement. The service provider selects an advertisement based on a matching process between the items selectable for advertising and the typical consumer profile corresponding to the client in question.

A method according to the invention can be implemented by carrying out the following steps 1 to 5:

(1) The service provider maintains an advertising database comprising selectable advertising records. Each advertising record is directly or indirectly associated with an item to be advertised and an item profile which describes a typical or probable buyer for the item in question. An advertising record is ‘selectable’ if the corresponding item can be selected for advertising, for example, because it relates to an advertiser that has bought the advertising space (a banner) which is being filled.

(2) When the client requests a service, the service provider determines at least one characteristic parameter of the client. Preferably, the characteristic parameter is or comprises the client's home address. This element of the invention is based on the discovery that the buying patterns of people living next to each other are much more similar than are the buying patterns of randomly selected people.

(3) The service provider uses the characteristic parameter(s) to request a typical consumer profile which is typical for a predetermined number of persons having substantially the same characteristic parameter(s). This element of the invention conceals the characteristics of individual consumers from advertising purposes. Preferably, the characteristic parameter(s) is/are requested from a separate legal entity, referred to as a ‘profile provider’.

(4) The service provider employs a matching process to select, among the selectable advertising records, at least one record which is associated with an item profile which matches the typical consumer profile. The service provider preferably employs weighted correlation analysis to find the item profile which gives the best match with the typical consumer profile.

(5) The service provider extracts from the selected advertising record(s) at least one item for advertising to the client, retrieves the corresponding advertisement from local storage or from the advertiser's web page and combines the retrieved advertisement with the service/information which the client requested.

Keeping the service provider and the profile provider as separate logical entities has the advantage that characteristics of individual consumers are concealed from advertising purposes. Instead, the advertisement selection is based on the concept of a ‘typical consumer’ having substantially equal characteristic parameters, such as the home address, as the client to whom the advertisement is to be delivered. Keeping them as separate legal entities (e.g. in separate organizations) has the added benefit that neither the service provider nor the advertisers have to collect information on the habits and social status of an individual client. Collecting and organizing huge amounts of typical consumer profiles, while simultaneously protecting the privacy of an individual consumer, is an enormous task. By virtue of the invention, the results of this task can be exploited by a large number of service providers and advertisers. The relevant typical consumer profile is based on a predetermined number of people, the number of which is chosen so as to meet the local legal requirements. If such legal requirements are changed, the changes in software are limited to the profile provider.

One aspect of the invention is a method for delivering advertising information from a service provider to a client. Another aspect of the invention is a computer arrangement for delivering advertising information to the client. The computer arrangement is the service provider's collection of hardware and software for delivering advertising information in connection with a requested service. Typically the computer arrangement comprises at least one Internet server and operator (support personnel). A prime example of a client terminal is a personal computer with an Internet browser.

### BRIEF DESCRIPTION OF THE DRAWINGS

The invention will be described in more detail by means of preferred embodiments with reference to the appended drawing wherein:

FIG. 1 is a block diagram illustrating a telecommunication system in which the invention can be used;

FIG. 2 is a signalling diagram illustrating a possible set of events in a system as shown in FIG. 1; and

FIG. 3 illustrates the various data structures used in a system as shown in FIG. 1.

### DETAILED DESCRIPTION OF THE INVENTION

FIG. 1 is a block diagram illustrating a telecommunication system in which the invention can be used. There are four main sections: a client (site) C, a service provider SP, several advertisers A1 - An (collectively denoted by reference sign A), and a profile provider PP. The client site comprises a client terminal CT, which can be a conventional desktop computer running an Internet browser. The client terminal CT is connected to the server site via a telecommunication network NW. The network NW can be for example the Internet or a closed subnetwork, commonly called ‘intranet’ or ‘extranet’.

The service provider site SP comprises a communications server CS and three logic sections, namely a service logic SL, a profile logic PL and an advertising logic AL. The data needed by the logic sections are denoted by respective reference signs SDB, PDB and ADB, where DB stands for a database. The service logic SL provides the service(s) actually requested by the client, such as e-commerce, banking, computer dating, etc. The profile logic PL converts the client's characteristic parameter(s) to a request for the typical consumer profile. An example of such conversion is the process of converting a home address to geographical coordinates. The advertising logic AL selects the item which is most likely to be attractive to the client. In lightly-loaded systems, the logic sections SL, PL and AL and the corresponding databases can be installed in the same computer which acts as the communication server CS. On the other hand, a heavily-loaded system may require several computers for performing some or all of the functions at the service provider SP.

The profile provider PP is a separate logical entity from the service provider SP. Preferably, it is also a separate legal entity, such as a server hardware and software arrangement maintained by a separate company. An example of a profile provider is known by the trade name of Mosaic by Experian Information Solutions, Inc (www.experian.com). Service retailers in various countries can be reached via Experian's home page. In Finland, for example, such a service is provided by Marknadsanalys Oy. The connection between the service provider SP and the profile provider PP may be implemented via the network NW (such as the Internet) or via a dedicated connection 11.

The advertisers A1 to An buy advertising space and time from the service provider SP. They may deliver advertising content to the service provider over the network NW (or on computer-readable media by mail). Business-wise there may be advertising agencies between the (original) advertisers and the SP, but such details are not relevant to understanding the invention.

The pairs of arrows illustrate information flow between the hardware and logic sections in FIG. 1. The client begins the process by sending his/her identification ID and a service request SR. The client's first session includes requesting the client's home address HA. The service request SR is conveyed to the service logic SL, which provides the requested service S. The home address HA is conveyed to the profile logic PL which converts the home address to the client's geographical coordinates XY. They are sent to the profile provider PP, which responds by returning a typical consumer profile TCP. The TCP in turn is conveyed to the advertising logic AL for selecting the advertising record AR of the item providing the best match (e.g. weighted correlation) with the TCP. The advertising record AR includes an advertisement locator AL which is used to retrieve the corresponding advertisement AD. In the scenario shown in FIG. 1, the advertisement AD is retrieved on-line from the corresponding advertiser A, but it could just as well be cached or stored locally within the SP. Finally the selected and retrieved advertisement AD is combined with the requested service S, and the combination (such as a web page having a banner) is sent to the client.

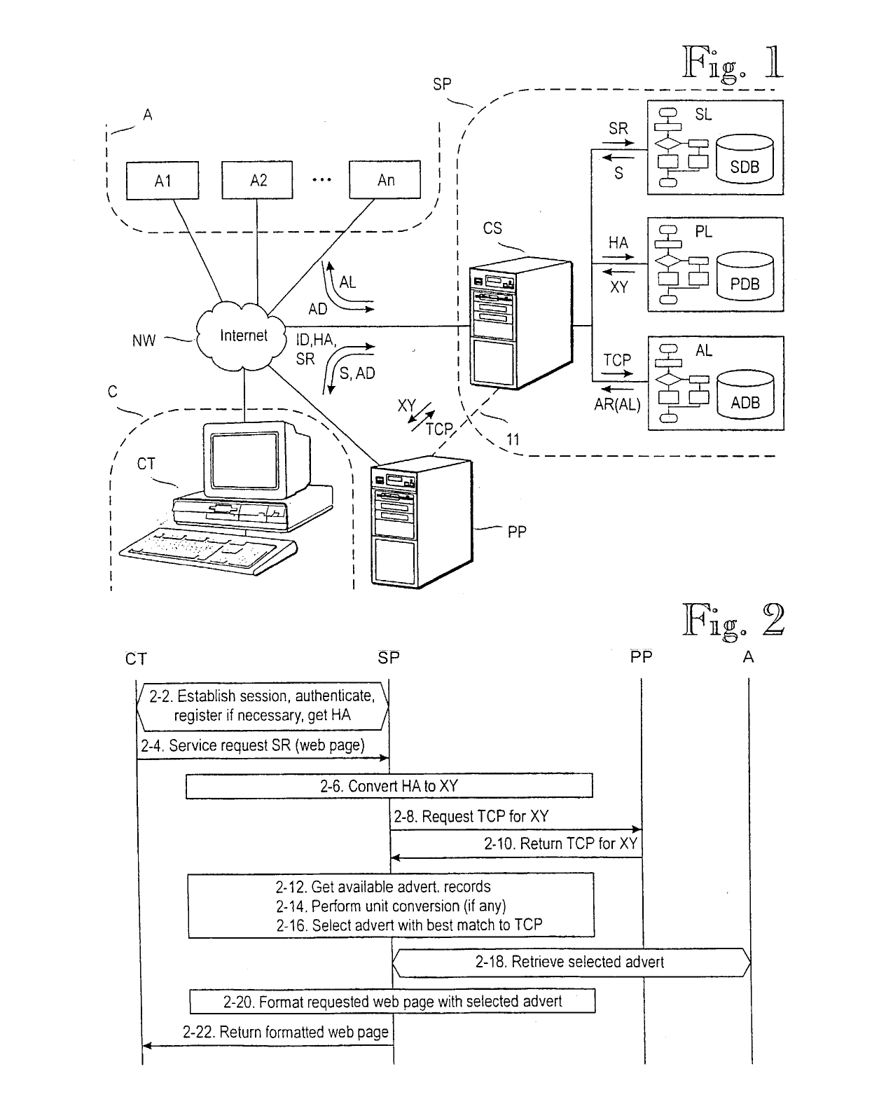

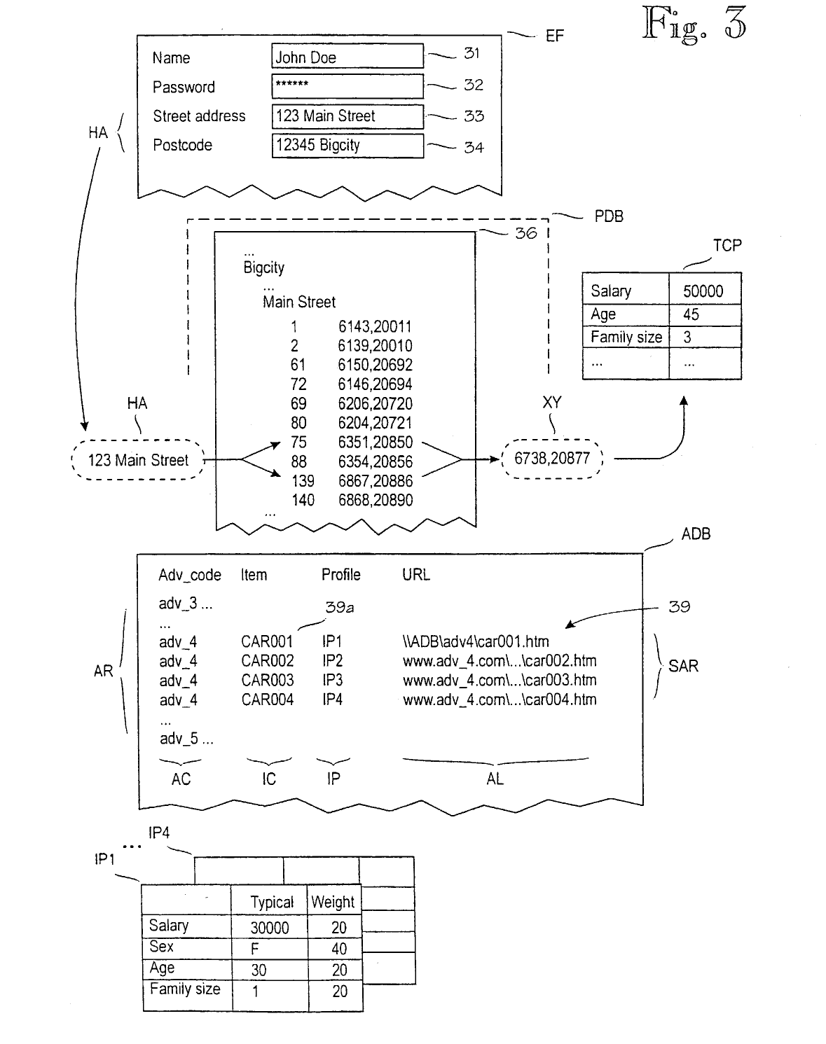

FIG. 2 is a signalling diagram illustrating a possible set of events in a system as described above. The events relating to the signalling diagram are easier to understand in the context of a concrete example, although it should be kept in mind that this example is intended for describing rather than limiting the embodiments of the invention. Let us assume that the service provider is a news publisher publishing on-line news. The clients may access a certain piece of news by navigating to the corresponding news page. Each news page has a space reserved for an advertisement, referred to as a ‘banner’. The service provider may sell such a banner for a certain time to a certain advertiser, which in this case may be an automobile manufacturer. The relevant question facing the service provider is: what car model of this particular manufacturer should be advertised to the client, or in other words: what car model has the best chance of being acquired by the client?

In step 2-2 an Internet session is established between the client terminal CT and the service provider SP. The first time the client accesses the service provider's site, the client is registered. The registration includes requesting the client's name and password (for identifying the client later). Additionally, the registration includes requesting the client's home address (street address and post/zip code), which will later be used for determining a typical consumer which corresponds to this particular client. The steps for session establishment and client registration are well known to those skilled in the art. In step 2-4 the client sends a service request SR, requesting the service provider to provide a certain service (to perform a function). The service request SR may as simple as a for example a command to navigate to a certain web page. For the purposes of this embodiment, it is essential that after step 2-4, the service provider knows the home address of and the service requested by the client.

In step 2-6 the service provider SP converts the client's home address HA to geographical coordinates XY. In step 2-8 the service provider SP sends the geographical coordinates XY to the profile provider PP. Based on the coordinates XY, the profile provider PP returns a typical consumer profile TCP in step 2-10.

In step 2-12 the service provider SP searches the advertising database ADB for selectable advertising records, i.e., records relating to advertisements which can be advertised in the banner(s) on the web page requested by the client at this point of time. In other words, the SP retrieves all advertising records relating to the advertiser(s) who has/have bought the banner(s) in question at this point of time.

In step 2-14 the service provider SP performs unit conversion, if necessary. For example, the typical consumer profile TCP returned by the profile provider PP may indicate a typical consumer's salary in the area in question in local currency units per month, whereas the advertiser (the automobile manufacturer) may indicate that a given car model is the most attractive to buyers earning approximately 30000 euros per year.

In step 2-16 the service provider SP selects the advertising record relating to the item having the best match with the typical consumer profile TCP. The item-with-typical consumer matching will be- described later in more detail in connection with FIG. 4.

In step 2-18 the service provider SP retrieves the advertisement relating to the selected advertising record. The advertisement may be stored locally in the advertising database ADB, or the ADB may contain only a link to the advertiser's web page from which the advertisement will be retrieved. In step 2-20 the service provider SP formats the web page requested by the client and inserts the retrieved advertisement in the banner. If the web page requested by the client has multiple banners, steps 2-12 through 2-18 are repeated for each banner. Finally, in step 2-22, the web page(s) with the banner is/are sent to the client terminal CT.

FIG. 3 illustrates the various data structures used in the system of FIG. 1. Reference sign EF denotes an entry form for an initial registration of the client. For the purposes of the preferred embodiments of the invention, four fields are relevant. The client's name 31 and password 32 will be used to identify the client during later sessions. The street address 33 and post/zip code 34 constitute the client's home address HA. The service provider SP parses the street address 33 to separate the street name and house number according to local conventions. (In some countries the house number precedes the street name, in others, it is the other way round.) The postcode 34 determines the correct city or other district (many street names exist in more than one city).

How can street addresses be converted to geographical coordinates? It is obviously impractical to store the geographical coordinates of each house. On the other hand, it is clearly insufficient to store just the endpoints of each street because some streets are curved, and at some streets the density of houses varies considerably. This problem can be solved by means of a suitable conversion table 36 and interpolation. The conversion table 36 has an entry for the endpoints of each street. Additionally, the table 36 has entries for locations where the street direction and/or the house density changes. For some streets, it may be sufficient to store only odd (or even) numbers, but there are also streets with a significant house number offset between the different sides of the street. Thus, the SP may use the following logic: if the house number in question has a certain parity (odd or even) and the street has entries for both parities, then only entries for the relevant parity will be used. The address-to-coordinates conversion proceeds as follows. The service provider SP first searches the conversion table 36 for the street name and house number in question. If no exact match is found, the next highest and lower house numbers will be selected, and the correct coordinates are calculated by linear interpolation. In the example shown in FIG. 3, the home address HA is ‘123 Main Street, 12345 Bigcity’. Since there is no entry for ‘123 Main Street’ the SP interpolates (linearly) between the next lowest house number 75 and the next highest house number 139. The coordinates XY are {6738, 20877}. Ideally, coordinates are stored for every street corner, which minimizes the error introduced by interpolation.

Reference sign ADB denotes the advertising database which comprises a table of advertising records AR. There is at least one advertising record AR for each item to be advertised. Each advertising record AR should have a field or link for each of the following: an item code and/or name IC, an item profile IP, an advertiser code AC and an advertising locator AL. Some of the advertising records AR can be selected. Such records are called selectable advertising records SAR. One example of determining the set of selectable advertising records SAR was described in connection with FIG. 2. In that example, a certain banner on a certain web page was sold to one advertiser for a certain time, and the advertiser code AC was used to retrieve the selectable advertising records SAR. The advertising locator AL is an address (such as a Universal Resource Locator) of the actual advertisement AD. The locator AL may point to the service provider's local storage or to a web page of the advertiser in question. The item profiles IP, IP1 - IP4 are used to determine which item is the most likely to be attractive to the typical consumer who lives in the area of the client in question. The structure of the item profiles IP may vary between advertisers. For instance, salary and family size are important criteria for car manufacturers but probably not for book publishers. Preferably, the item profiles IP also comprise a relative weight factor. For instance, buyers of sport cars are predominantly male, whereas buyers of medium-sized sedans are more evenly divided between the sexes. Correspondingly, an item profile of a sports car is likely to have an entry of ‘male’ and a high weight factor for the sex.

The retrieval of a typical consumer profile TCP from the profile provider PP was already described in connection with FIG. 2 (steps 2-8 and 2-10). For the purposes of this embodiment, the TCP may contain entries for income, age, family size, activities and monthly expenditures on groceries, books, etc. The TCP may or may not indicate a probable value for sex, but the client's sex is best determined based on the client's name or a separate entry (not shown) in the entry form EF.

The advertisement selection process will now be described in connection with a concrete example. Let us assume that the banner to be filled has been sold to a car manufacturer that—for the purposes of this example—has four models: a city car, a 4-door sedan, a station wagon (STW) and a sports car. The corresponding item profiles are as follows:

| | City | W (%) | Sedan | W (%) | STW | W (%) | Sport | W (%) |
|---|---|---|---|---|---|---|---|---|
| Salary | 30000 | 20 | 40000 | 30 | 50000 | 25 | 60000 | 40 |
| Sex | F | 40 | M | 0 | M | 25 | M | 40 |
| Age | 30 | 20 | 40 | 30 | 50 | 20 | 35 | 10 |
| Family size | 1 | 20 | 3 | 40 | 4 | 30 | 2 | 10 |
| | | 100 | | 100 | | 100 | | 100 |

. . . or in plain text, a typical buyer for a city car is a 30-year old single woman earning 30000 euros per year. For this car, the sex has the highest weight factor (40%), while salary, age and family size each have a weight factor of 20%. Let us further assume that the profile provider PP returns a typical consumer profile TCP indicating a salary of 50000, an age of 45, a family size of 3. In this example, the TCP does not indicate the sex, but it can be determined implicitly by means of the client's name or explicitly by means of a separate field (not shown) in the entry form EF. Let us assume that our client is a woman. In this example, the salary of 50000 euros seems to indicate a perfect match with the station wagon, whereas the city car is the only model the buyers of which are predominantly women.

According to a preferred embodiment of the invention, the service provider SP employs weighted correlation analysis to determine the most attractive car to the client. Let N_{TCP} and N_{IP} denote corresponding parameters (such as age or salary) in the TCP and IP, respectively. For each parameter pair (N_{TCP} and N_{IP}), the corresponding correlation factor can be calculated as follows:

Correlation=1−ABS(N_{IP}−N_{TCP})/MAX(N_{IP}, N_{TCP}),

where ABS means absolute value and MAX means maximum or ‘the larger of’.

For the sex, the correlation can be set to zero or one, depending on whether the client in question is of the same sex as the one indicated by the item profile IP. The weighted correlation is the above correlation multiplied by the corresponding weight in the item profile IP. The results of the calculations are as follows:

| | City car | | Sedan | | STW | | Sport | |
|---|---|---|---|---|---|---|---|---|
| | Corr | W.corr | Corr | W.corr | Corr | W.corr | Corr | W.corr |
| Salary | 0.60 | 12.00 | 0.80 | 24.00 | 1.00 | 25.00 | 0.80 | 32.00 |
| Sex | 1.00 | 40.00 | 0.00 | 0.00 | 0.00 | 0.00 | 0.00 | 0.00 |
| Age | 0.67 | 13.33 | 0.89 | 26.67 | 0.89 | 17.78 | 0.78 | 7.78 |
| Family | 0.33 | 6.67 | 1.00 | 40.00 | 0.67 | 20.00 | 0.67 | 6.67 |
| Score | | 72.00 | | 90.67 | | 62.78 | | 46.44 |

Thus the 4-door sedan, having the highest score, appears to be the most attractive model, and it will be selected for advertising.

The actual profiles provided by the Experian system are much more complex than the ones shown in connection with these examples, but the simple example profiles are sufficient to illustrate the concept of the invention.

The advertisement selection process described so far has a slight drawback, i.e., a client returning to the same web page sees the same advertisement repeatedly, as long as the banner on that web page is sold to the same advertiser. For example, the web page may list used cars, and the client checks this page every day. According to a further preferred embodiment of the invention, the service provider SP disfavours advertisements which have recently been shown to the client. This can be accomplished, for example, by maintaining a client-specific cache of the few (such as 10) of the most recent advertisements shown to this client. If an advertisement is listed in the client-specific cache, some points may be deducted from the score of the item in question. In the previous example, let us further assume that the client has recently seen the advertisement for the sedan. Accordingly, 20 points are deducted from its score of 90.67, leaving 70.67. In this case, the client would see an advertisement of the city car with a score of 72 points.

In addition to the apparent commercial advantages, the invention has certain technical advantages too. For example, telecommunication resources can be saved because customized advertising requires less bandwidth than randomly selected advertising does. Also, storage space and labour is saved because the invention relieves the service providers of the need to maintain a client profile database.

Although the invention has been described in connection with preferred embodiments, it is not limited to these examples, but it may be varied within the scope of the appended claims.

1. A method for delivering advertising information (AD) from a service provider (SP) to a client (C),
characterized by:
(1) maintaining an advertising data base (ADB) comprising selectable advertising records (SAR), each advertising record being directly or indirectly associated with an item (39a) and an item profile (IP1 - IP4);
(2) determining at least one characteristic parameter (HA) of the client (C);
(3) using the at least one characteristic parameter (HA) to determine a typical consumer profile (TCP) which is typical of a predetermined number of people having substantially the same at least one characteristic parameter (HA);
(4) selecting, among the selectable advertising records (SAR), at least one advertising record (39) which is associated with an item profile (IP1) which matches the typical consumer profile (TCP), and
(5) extracting at least one item (39a) for advertising to the client (C) from the at least one selected advertising record (39).

2. A method according to claim 1, characterized by selecting the predetermined number of people such that it fulfils a legal requirement that data on an individual person not be used for advertisement selection.

3. A method according to claim 1 or 2, characterized in that the at least one characteristic parameter (HA) comprises the client's (C) home address.

4. A method according to claim 3, characterized in that the using step (3) comprises
determining the client's map location (XY) based on the home address (HA); and
determining the typical consumer profile (TCP) based on the client's map location (XY).

5. A method according to any one of the preceding claims, characterized by maintaining at least one translation table for converting between dissimilar units in the item profiles (IP1 . . . IP4) and the typical consumer profiles (TCP).

6. A server computer arrangement (SP), capable of being operatively coupled to a terminal (CT) of a client (C), said server computer arrangement comprising a service logic (SL, SDB) for providing a service (S) in response to a service request (SR) from said client;
characterized by
an advertising data base (ADB) comprising a set of selectable advertising records (SAR), each of which is directly or indirectly associated with an item (39a) and an item profile (IP1 - IP4);
input means (2-4, EF) for receiving at least one characteristic parameter (HA) of the client (C);
a profile logic (PL, 2-6 . . . 2-10) for retrieving, based on said at least one characteristic parameter (HA), a typical consumer profile (TCP) which is typical of a predetermined number of people having substantially the same at least one characteristic parameter (HA); and
an advertising logic (AL) for:
selecting (2-16), among the selectable advertising records (SAR), at least one advertising record (39) which is associated with an item profile (IP1) which matches the typical consumer profile (TCP), and for
extracting at least one item (39a) for advertising (2-18 . . . 2-22) to the client (C) from the at least one selected advertising record (39).

7. A computer-readable medium containing computer software, characterized in that executing said software in a server computer arrangement (SP) which is operatively coupled to a client terminal (CT) causes the server computer arrangement to execute the steps of any one of claims 1 to 5.
